(19) United States
(12) Patent Application Publication
(10) Pub. No.: US 2024/0095445 A1
(43) Pub. Date: Mar. 21, 2024

(54) SYSTEMS AND METHODS FOR LANGUAGE MODELING WITH TEXTUAL CLINCAL DATA

(71) Applicant: CADENCE SOLUTIONS, INC., New York, NY (US)

(72) Inventor: Ashwyn SHARMA, Seattle, WA (US)

(73) Assignee: CADENCE SOLUTIONS, INC., New York, NY (US)

(21) Appl. No.: 17/817,554

(22) Filed: Aug. 4, 2022

Related U.S. Application Data
(63) Continuation of application No. 17/812,522, filed on Jul. 14, 2022, now abandoned.

(51) Int. Cl. G06F 40/20; G06F 40/103; G06F 40/166; G06F 40/30; G06N 20/00

(52) U.S. Cl. CPC G06F 40/20; G06F 40/103; G06F 40/166; G06F 40/30; G06N 20/00

(57) ABSTRACT

A composite clinical language modeling system that can leverage textual attributes of a patient's medical record for analytics, visualizations and accessibility. The composite clinical language model leverages a trainer module that fine-tunes a pre-trained language model using this text corpus, producing a model that can be customized for specific use cases. This model is then used to produce embeddings from input text which can then be used for several task-specific natural language processing models, wherein each task-specific natural language processing model has its own individual transfer learning loop that is responsible for continuously improving and fine-tuning task-specific natural language processing models for these specific tasks.

### CROSS-REFERENCE TO RELATED APPLICATIONS

This application is a continuation of U.S. application Ser. No. 17/812,522 filed Jul. 14, 2022, which is incorporated by reference in its entirety.

### BACKGROUND

Advancements to software and hardware have revolutionized the medical industry in a variety of ways. For example, in certain clinical environments, clinicians have turned to technology to improve their processes for billing and maintaining patient records. One notable development that has transformed such processes was the advent of electronic health records. An electronic health record is a digital record of health information that would typically be produced in paper form in a clinical setting.

Electronic medical record (EMR) systems enable the documentation, storage, and retrieval of electronic health records, such as patient records, digitized charts, and other documents created by clinicians. Many of these documents contain categorical, numerical, and textual attributes. However, unlike other data types, text-based attributes are harder to analyze, because clinical natural language (i.e., medical lexicon) is difficult to model. Modern natural language processing (NLP) systems require copious amounts of annotated data to effectively perform NLP tasks. This issue presents a particular challenge in a clinical environment given that a large fraction of the words are esoteric in nature.

Conventional EMR systems suffer from poorly trained models and one size fits all machine learning techniques that are applied to, but are not well suited for, every clinical use case. Indeed, conventional EMR systems implementing language models were often trained from scratch and for very specific tasks. Accordingly, there is a need for systems and methods that overcome the deficiencies of prior art systems by intelligently analyzing textual data and providing tools that uncover numerous insights stored on EMR systems.

### SUMMARY

The system and methods described herein provide a novel composite clinical language modeling system that can leverage textual attributes of a patient's medical record for analytics, visualizations and accessibility. Moreover, the techniques discussed herein overcome the deficiencies of conventional approaches by implementing a unique combination, including a trainer module configured to fine-tune a pre-trained language model using a well-trained text corpus that avails itself of clinician feedback and multiple task-specific natural language models engaging individual Transfer Learning Loop (TLL) modules responsible for continuously improving and fine-tuning models for these specific tasks.

In one embodiment, the composite clinical language modeling system may include a server comprising one or more processors and a non-transitory memory, in communication with the server, storing instructions that when executed by the one or more processors, cause the one or more processors to implement comprising: receiving a document in a first format, converting the document to a second format by redacting protected health information included on the document, pre-training a language model on a corpus, wherein the corpus includes the document in the second format, feeding embeddings created by the language model to one or more task-specific NLP models, and fine tuning each of the one or more task-specific natural language processing models via a transfer learning loop and based on input from a user device.

In another embodiment, the composite clinical language modeling system may include a computer-implemented method comprising: receiving a document in a first format, converting the document to a second format by redacting protected health information included on the document, pre-training a language model on a corpus, wherein the corpus includes the document in the second format, feeding embeddings created by the language model to one or more task-specific NLP models, and fine tuning each of the one or more task-specific NLP models via a TLL and based on input from a user device.

In another embodiment, the composite clinical language modeling system may include a non-transitory computer-readable medium storing instructions, that when executed by one or more processors, causes the one or more processors to implement the instructions for: receiving a document in a first format, converting the document to a second format by redacting protected health information included on the document, pre-training a language model on a corpus, wherein the corpus includes the document in the second format, feeding embeddings created by the language model to one or more task-specific NLP models, and fine tuning each of the one or more task-specific NLP models via a TLL and based on input from a medical user device.

Notably, in some of the previously discussed embodiments, the one or more task-specific NLP models are fine-tuned based on their own task-specific training dataset.

In some of the previously discussed embodiments, the input from the user device may include feedback, and each of the one or more task-specific NLP models is configured to receive feedback from the user device in response to performing its specific NLP function. The feedback may include data indicative of a confirmation or a correction of an output provided to the user device by the one or more task-specific NLP models.

In some of the previously discussed embodiments, the language model may be trained on a training dataset including medical lexicon, clinical documents, and clinical images. In addition, the one or more task-specific NLP models are configured to perform specific tasks, namely: classification, search and ranking, autocomplete, and topic modeling.

### BRIEF DESCRIPTION OF THE FIGURES

FIG. 1 illustrates a computing environment, according to various embodiments of the present disclosure.

FIG. 2 illustrates a composite clinical language modeling framework, according to various embodiments of the present disclosure.

FIG. 3 illustrates a transfer learning loop framework, according to various embodiments of the present disclosure.

FIG. 4 illustrates a fine tuner workflow diagram, according to various embodiments of the present disclosure.

FIG. 5 illustrates a method for training a composite clinical language modeling system, according to various embodiments of the present disclosure.

FIG. 6 illustrates a block diagram for a computing device, according to various embodiments of the present disclosure.

### DETAILED DESCRIPTION

Embodiments of the present disclosure relate to systems and methods for language modeling with clinical data using a clinical language modeling system comprised of artificial intelligence/natural language processing and multiple task-specific natural language models. The implementation of these novel concepts may include, in one respect, training of one or more artificial intelligence techniques, and in particular, one or more NLP models based on clinical documents and feedback from clinicians. Additionally, these novel concepts may include feeding embeddings produced by a language model into task-specific natural language processing models, such as classification, search and rank, autocomplete, and topic modeling, and performing the one or more natural language processing models in response to a request from a user device.

The disclosed principles are described with reference to electronic health records and processing by an EMR system, but these principles may apply to any type of document requiring processing and or a response by a recipient of the document and any electronic service or system that processes or uses said documents. Accordingly, the disclosed principles are not limited to use with clinical documents.

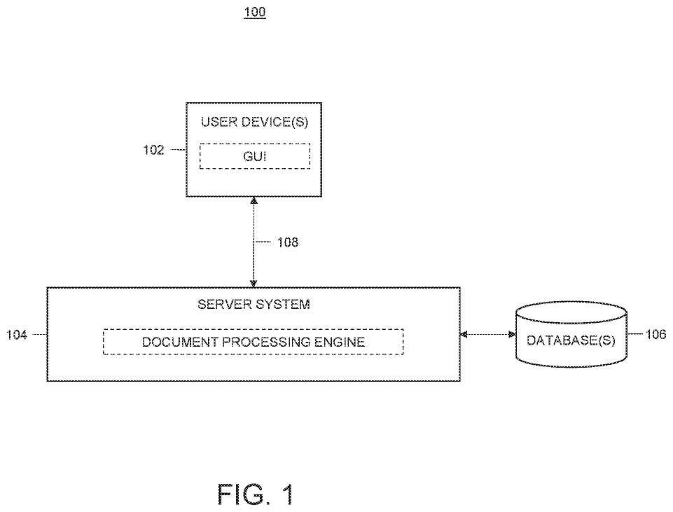

Referring to FIG. 1, computing environment 100 may be configured to automatically and intelligently process documents such as clinical documents, according to embodiments of the present disclosure. Computing environment 100 may include one or more user device(s) 102, a server system 104, and one or more databases 106 communicatively coupled to the server system 104. The user device(s) 102, server system 104, and database(s) 106 may be configured to communicate through network 108.

In one or more embodiments, user device(s) 102 is operated by a user (e.g., a clinician). User device(s) 102 may be representative of a mobile device, a tablet, a desktop computer, or any computing system having the capabilities described herein. Users may include, but are not limited to, individuals such as, for example, individuals, clinicians, companies, prospective clients, and or customers of an entity associated with server system 104, such as individuals who have received and or produce clinical documents and are utilizing the services of, or consultation from, an entity associated with that document and server system 104.

User device(s) 102 according to the present disclosure may include, without limitation, any combination of mobile phones, smart phones, tablet computers, laptop computers, desktop computers, server computers or any other computing device configured to capture, receive, store and/or disseminate any suitable data. In one embodiment, a user device(s) 102 includes a non-transitory memory, one or more processors including machine readable instructions, a communications interface which may be used to communicate with the server system (and, in some examples, with the database(s) 106), a user input interface for inputting data and/or information to the user device and/or a user display interface for presenting data and/or information on the user device. In some embodiments, the user input interface and the user display interface are configured as an interactive graphical user interface (GUI). The user device(s) 102 are also configured to provide the server system 104, via the interactive GUI, input information (e.g., documents such as patient records, patient charts, clinician notes, and diagnoses) for further processing. In some embodiments, the interactive GUI is hosted by the server system 104 or provided via a client application operating on the user device. In addition, the interactive GUI may include multiple distinct regions where results can be provided, feedback can be inputted, and clinical documents can be created, updated, and revised. In some embodiments, a user operating the user device(s) 102 may query server system 104 for information related to a received document (e.g., a clinical document).

Server system 104 hosts, stores, and operates a document processing engine, or the like, to automatically and intelligently process documents for, and to train, a composite clinical language modeling system. For example, if the server system 104 supports or provides an EMR system, it will include the capability to process clinical documents.

The document processing engine may asynchronously monitor, retrieve according to a schedule, and enable the submission of documents (e.g., clinical documents) received by the user device(s) 102. The server system 104, in response to receiving the one or more documents, converts the document(s) to a computer interpretable format via one or more computer vision techniques and extracts text from the document(s). Server system 104 additionally redacts protected health information from the document(s). In one or more embodiments, during the redaction process, server system 104 removes predetermined objects such as the patient's name, address, social security number, images, unique identifying characteristics, and the like. Server system 104 may then add the redacted document to a training dataset that includes a corpus of other redacted document(s) (e.g., clinical documents). Server system 104 may leverage a pre-trained language model and a trainer on the corpus of clinical documents, wherein the result of the training is a refined new version of a language model. The language model, via server system 104, may then map the text (i.e., words on each document within the corpus) to vectors, in an embedding process. The embeddings are then fed as the input to each task-specific NLP model. For example, the language model may feed the embeddings as the input to one or more task-specific NLP models, including but not limited to a classification model, search and rank model, autocomplete model, and topic model. In addition, server system 104 may enable usage of the task-specific NLP models by clinicians operating user device(s) 102 for various clinical purposes. Server system 104 may receive feedback (e.g., input indicative of a confirmation or correction) from clinicians operating the user device(s) 102 and leverage that feedback to fine-tune the task-specific NLP model(s) that were used by the clinician. The server system 104 may further generate instructions for displaying documents or portions of documents stored in the training dataset and actions that can be taken with said document(s), via a GUI that operates on the user device(s) 102. The aforementioned techniques provide accurate and automated solutions that improve upon prior methods for analyzing clinical documents.

The server system 104 may be further configured to implement two-factor authentication, Secure Sockets Layer (SSL) protocols for encrypted communication sessions, biometric authentication, and token-based authentication. The server system 104 may include one or more processors, servers, databases, communication/traffic routers, non-transitory memory, modules, and interface components.

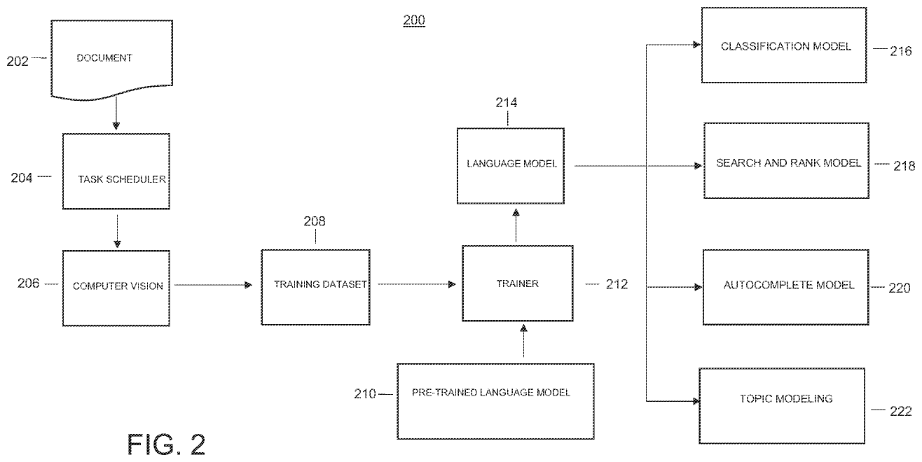

Database(s) 106 may be locally managed and/or a cloud-based collection of organized data stored across one or more storage devices and may be complex and developed using one or more design schema and modeling techniques. In one or more embodiments, the database system may be hosted at one or more data centers operated by a cloud computing service provider. The database(s) 106 may be geographically proximal to or remote from the server system 104 configured for data dictionary management, data storage management, multi-user access control, data integrity, backup and recovery management, database access language application programming interface (API) management, and the like. The database(s) 106 are in communication with the server system 104 and the user device(s) 102 via network 108. The database(s) 106 store various data, including one or more tables, that can be modified via queries initiated by users operating user device(s) 102. In one or more embodiments, various data in the database(s) 106 will be refined over time using a natural language processing model, for example the language model discussed below with respect to FIGS. 2-5. In one or more embodiments, database(s) 106 additionally stores training data and historical training data used to train and refine the language model or the one or more task-specific NLP models. Additionally, the database system may be deployed and maintained automatically by one or more components shown in FIG. 1.

Network 108 is any suitable network, including individual connections via the Internet, such as cellular or Wi-Fi networks. In some embodiments, network 108 connects terminals, services, and mobile devices using direct connections, such as radio frequency identification (RFID), near-field communication (NFC), Bluetooth™, low-energy Bluetooth™ (BLE), Wi-Fi™, ambient backscatter communication (ABC) protocols, Universal Serial Bus (USB), wide area network (WAN), local area network (LAN), or the Internet. Because the information transmitted may be personal or confidential, security concerns may dictate that one or more of these types of connection be encrypted or otherwise secured. In some embodiments, however, the information transmitted may be less personal and, therefore, the network connections may be selected for convenience over security.

For example, network 108 may be the Internet, a private data network, virtual private network using a public network and/or other suitable connection(s) that enables components in computing environment 100 to send and receive information between the components of computing environment 100.

Referring to FIG. 2, a composite clinical language modeling framework 200 is depicted, according to various embodiments of the present disclosure. Framework 200 provides components and processes for evaluating a document (e.g., clinical documents) using NLP and task-specific NLP models. These features provide an improvement of the prior art, which typically provided only basic electronic document retrieval. As shown, framework 200 includes a task scheduler component 204 (e.g., cronjob), which implements a task scheduler configured to schedule tasks to run periodically, at preset times, dates, and/or intervals. Framework 200 additionally includes a computer vision component 206 configured and capable of receiving a document 202 (e.g., a clinical document that may include protected health information) and redacting protected health information from the document. In one embodiment, the computer vision component 206 converts the document from a first format (e.g., PDF format) to a second format (e.g., JPEG format) readable by optical character recognition (OCR). Computer vision component 206 may be further configured to save the text read from the OCR engine as a single text file. In some instances, computer vision component 206 may be triggered in response to framework 200 receiving a document that is in a non-textual format (e.g., an image).

As shown, framework 200 includes a training dataset 208. Training dataset 208 is a corpus comprised of numerous documents (e.g., clinical documents including patient records like charts, diagnoses, medical test results, prescription information, clinician notes) that may or may not have been previously run through the language model component 214.

Framework 200 may additionally include pre-trained language model component 210 and trainer component 212. Pre-trained language model component 210 may be a deep learning models (e.g., transformers) which are trained on the training dataset 208 to perform specific NLP tasks. By incorporating the pre-trained language model component 210, framework 200 may improve its accuracy and reduce the amount of training time required to complete NLP tasks. Pre-trained language model component 210 may include NLP models including but not limited to: Named Entity Recognition (NER), which is an NLP task where the model tries to identify the type of every word/phrase which appears in the input text; sentiment analysis, which is an NLP task where a model tries to identify if the given text has positive, negative, or neutral sentiment; machine translation is an NLP task where a model tries to translate sentences from one language into another; text summarization is an NLP task where a model tries to summarize the input text into a shorter version in an efficient way that preserves all important information from the input text; natural language generation is an NLP task where the model tries to generate natural language sentences from input data or information given by NLP developers; speech recognition is an NLP task where a model tries to identify what the user is saying; content moderation which is an NLP task where a model tries to identify the content which might be inappropriate (offensive/explicit), or should not be shown on public channels like social media posts, comments; and automated question answering (QA) systems: Automated QA systems try to answer user-defined questions automatically by looking at the input text.

Pre-trained language model component 210 may be trained to understand the grammatical and semantic structure of the corpus composed of clinical documents and medical lexicon. The pre-trained language model component 210 may be trained for days, weeks, or months to accurately understand the medical domain-specific language.

The trainer component 212 may be a training engine configured to loop over the training dataset and update model parameters. The trainer component 212 may receive the training dataset 208 and the pre-trained language model component 210 as input for one or more training models such as Bidirectional Encoder Representations from Transformers (BERT), Generative Pre-trained Transformer 2 (GPT2), and/or Robustly Optimized BERT Pre-training Approach (RoBERTA). The trainer component 212 may train and modify a language model implemented by the language model component 214 based on the aforementioned input, models and parameters.

Language model component 214 may implement a language model configured for interpreting a text within a document (e.g., clinical document) and producing word embeddings for downstream use. Language model component 214 may be particularly configured for implementing a language model that can interpret medical terminology, medical codes (e.g., International Classification of Diseases (ICD) codes), medical diagnoses, handwritten medical notes, prescription data, data on charts, images, x-rays, and the like. Language model component 214 may additionally be configured to make associations between text within a document and known acronyms. The language model implemented by language model component 214 may further be configured for generating word embeddings as an output and transferring the word embeddings to the one or more task-specific NLP models as input.

Framework 200 may also include one or more task-specific NLP models. For example, framework 200 may include task-specific NLP models and components such as a classification model component 216, a search and rank model component 218, an autocomplete component 220, and/or the topic modeling component 222.

The classification model component 216 may, given a text and/or document, classify the text and/or document into specific categories and or labels via a classification model. In addition, or alternatively, classification model component 216 may predict a specific attribute pertaining to the received text. In one embodiment, classification model component 216 may predict one or more clinical labels. In another embodiment, classification model component 216 may predict an ICD code for a patient diagnosis. In one example in order to classify or predict an attribute regarding the text, the classification model component 216 may have received a clinical document (e.g., a patient record) wherein the words within the document are split into vectors and the classification model component 216 attempts to predict the ICD code that was included on the received text. The classification model implemented by the classification model component 216 may be a supervised NLP task and further include its own neural network separate from language model component 214 and the other task-specific NLP models. There may be a predefined number of labels or categories by which the classification model may assign and label a text or document. Notably, the classification model may be evaluated based on how accurate its predictions are. Accordingly, the classification model component may leverage one or more loss functions to measure how far an estimated value is from its true value. Classification model component 216 may implement one or more loss functions including but not limited to binary cross entropy loss, categorical cross entropy loss, hinge loss, and/or Kullback Leibler Divergence Loss.

Search and rank model component 218 may implement a semi-supervised search and rank model trained to search a corpus of text in response to receiving a query and generate search results that are ranked in the order of relevance, given the search terms in the query. Search and rank model component 218 may receive word embeddings (i.e., vectors) from language model component 214 as input and feed it to its own separate neural network. Similarly, the search and rank model may convert the query into a vector. A vector space model may then be used to measure the similarity between a collection of documents and a query. Search and rank model component 218 may use cosine similarity to measure the similarity between two vectors. In a mathematical sense, it measures the cosine of the angle between two vectors in a multi-dimensional space. Two vectors with the same direction have a cosine similarity of 1, two vectors which direction deviate by 90° relative to each other have a cosine similarity of 0 because the cosine of 90° is 0, and two vectors diametrically opposed each other have a similarity of −1 because the cosine of 180° is −1. The cosine similarity is particularly used in positive space, where the result is bounded in the range of 0 until 1. The search and rank model may calculate the cosine similarity between the query and each document within a corpus and generate a search results list, wherein relevant documents are sorted in ascending or descending order. In one embodiment, a clinician could prompt server system 104 with a query (e.g., a semantic search) for a patient diagnosis, and search and rank model component 218 would evaluate and identify the documents (i.e., word embeddings) with the cosine similarity values most similar to the query, and list those documents as search results in predefined order (e.g., ascending or descending order) by relevance.

Framework 200 may additionally include an autocomplete component 220. Autocomplete component 220 may include a task-specific autocomplete model. The autocomplete component 220 may be configured to recognize, predict, and generate complex programming language syntax to improve its process for recognition, prediction, and language generation through various training techniques.

In one embodiment, the autocomplete model may be a semi-supervised model configured to suggest the next word to a user (e.g., a clinician) entering in data (e.g., text) in a data field. For example, server system 104 may receive a query or a string of text from a clinician operating an interactive GUI on a user device. The autocomplete model may tokenize the text in the query or the string of text, thereby reducing the query or string of text into smaller segments, which aids the autocomplete in interpreting the context of the query. In addition, one technique the autocomplete model may implement is a masking technique, wherein the text elements are masked (i.e., hidden) from the autocomplete model, thereby providing the autocomplete model with incomplete query, word, or string of text, and subsequently asking the autocomplete model to accurately generate a complete query, word, or string of text by predicting the masked query syntax elements. Accordingly, training may include predicting, via the autocomplete model, masked text in the query, word, or string of text. For example, the autocomplete model may receive a query with masked query syntax elements as input and attempt to predict the masked query syntax elements by bidirectionally analyzing the query and the non-masked query syntax elements for context. The autocomplete model can interpret context by applying attention weights to the non-masked query syntax elements adjacent to the masked query syntax elements, which influences the prediction process by applying a weight to every non-masked query syntax element. Additionally, the autocomplete model can analyze the query syntax elements in parallel, therefore allowing the autocomplete model the ability to predict one or more masked query syntax elements simultaneously. The autocomplete model may calculate loss of the autocomplete predictions. For example, the autocomplete model may evaluate how well it predicted the masked input. The autocomplete model may implement one or more loss functions in calculating the loss, such as, but not limited to, means squared error, likelihood loss, and log loss (cross entropy loss). The calculated loss may be fed into the autocomplete model to retrain the model.

Framework 200 may additionally include a topic modeling component 222. The topic modeling component 222 may implement a topic model that is an unsupervised learning model that identifies hidden relationships in data. The topic model may discover topics using a probabilistic framework to infer themes within the data based on the words observed in the documents. In one embodiment, the topic modeling component 222 may be a Latent Dirichlet Allocation (LDA) model. The LDA model may discover the different topics that the documents represent and how much of each topic is present in a document. Said differently, the topic model may extract the patterns of word clusters and frequencies of words in the document. The LDA model may have three important hyperparameters: ‘alpha’ which represents document-topic density, ‘beta’ which represents word density in a topic, ‘k’ or the number of components representing the number of topics into which one wants the document to be clustered or divided. The topic model implemented by topic modeling component 222 may parse through a corpus within a training dataset and identify themes or topics. In one embodiment, the topic model may analyze the corpus and identify trends related to any number of clinical categories including but not limited to hospitalization, patient symptoms, patient medications, and the like. In furtherance of identifying themes or topics, the topic model may identify or provide a visual aid (e.g., a graph) for identifying clusters of terms. Here, the number of terms may be a predefined number.

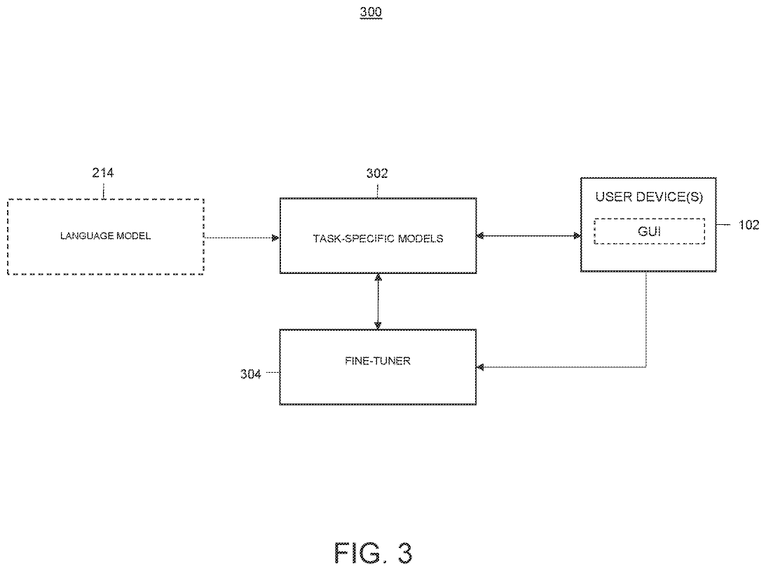

Referencing FIG. 3, a TLL framework 300 is depicted, according to one or more embodiments of the present disclosure. Framework 300 may include one or more components configured for fine tuning one or more of the task-specific NLP models based on various types of feedback (e.g., input indicative of a confirmation or correction of an output provided by the one or more task-specific NLP models). Framework 300 may include language model component 214, task-specific model(s) 302 (which includes the task-specific models: 216, 218, 220, and 222 in FIG. 2), fine-tuner 304, and user device(s) 102. Framework 300 improves upon conventional models by leveraging the pre-existing knowledge of language model component 214 and applying its knowledge to a domain specific task.

In one embodiment, framework 300 may receive feedback from a user (e.g., a clinician) operating user device(s) 102. The feedback from the clinician may be in the form of input that confirms the accuracy of the output and/or results transmitted to the user device from a task-specific NLP model. For example, a clinician may submit a search query for a list of diagnoses associated with a particular patient. The search and rank model component 218 may be invoked by server system 104 and a series of search results may be presented to the clinician via the user device. The clinician may provide feedback by rejecting one of the search results for one or more reasons (e.g., as being inaccurate or irrelevant). The feedback may be transmitted from user device to the fine-tuner 304.

The fine-tuner 304 may implement one or more of fine tuning with target data, layer freezing, and modifying a layer-wise learning rate. In some instances, fine tuning each of the task-specific NLP models 302 with target data, may include training the entire model based on a new/modified dataset. Here, the error is back-propagated through the entire architecture and the pre-trained weights of the model are updated based on the new dataset.

In an instance where fine tuning the task-specific NLP models 302 includes layer-freezing, the task-specific NLP models 302 may be partially trained. For example, the initial parameters and weights in some of the layers of the task-specific NLP models 302 can be kept the same (i.e., frozen), while other layers can be retrained. Experimentation can be done to test how many layers need to be frozen and how many need to be retrained.

In another instance where fine tuning the task-specific NLP model 302 includes taking a layer-wise learning rate approach, the task-specific NLP model 302 may have one or more hyperparameters (i.e., learning rates) for one or more layers within the model modified. Here, the learning rate is a hyperparameter that controls how much to change the model in response to the estimated error each time the model weights are updated. As such, the learning rate controls how quickly the task-specific model is adapted to the task-specific problem.

Notably, each of the task-specific NLP models 302 benefits from knowledge of the language model component 214, however each of the task-specific NLP models 302 has its own individual TLL framework 300, wherein it can be fine-tuned as described above. In one embodiment, as it relates to the classification model component 216, its TLL framework may fine-tune its model by evaluating one version of the model in view of its number of correct predictions (e.g., gleaned from feedback). In one non-limiting embodiment, clinicians may assign the correct label or category as a form of feedback. For example, a clinician may request a patient diagnosis associated with a patient, and in response, the classification model may attempt to predict the patient's ICD-10 code and transmit it to the clinician. The clinician may then confirm whether the predicted ICD-10 code is accurate and/or provide the correct ICD-10 code (i.e., label). The framework 300 associated with the classification model component 216 may evaluate its correct predictions using area under the curve (AUC) analysis. The AUC quantifies the classification model of the classification model component 216 ability to separate the labels/categories by capturing the count of positive predictions which are correct against the count of positive predictions that are incorrect at different thresholds.

The framework 300 associated with the search and rank model component 218 may evaluate its model based on the one or more evaluation metrics, including but not limited to precision at K, recall at K, mean reciprocal rank, discounted cumulative gain, and/or expected reciprocal rank.

The framework 300 associated with the autocomplete component 220 may evaluate its model by evaluating the next token accuracy. In this instance, the framework 300 associated with the autocomplete component 220 may evaluate and try to hone it by attempting to improve its next token accuracy. Here, the autocomplete model may be evaluated based on the feedback from the clinician and further based on one or more metrics, such as BLEU, METEOR, CIDEr, and SPICE. Through experimentation and ongoing feedback, the transfer learning loop framework may adjust parameters associated with the autocomplete model.

The framework 300 associated with the topic modeling component 222 may evaluate its model next token accuracy by evaluating the topic model implemented by the topic modeling component 222 according to the feedback and one or more metrics, such the supervised judgment and/or quantitative metrics. In one instance, as it relates to supervised judgment, the topic model may be evaluated by observing the most commonly mentioned words for each topic, word intrusion, or topic intrusion. In addition, as it relates to quantitative metrics, the topic model may be evaluated based on perplexity and/or coherence. Once evaluated, the topic model may be fine-tuned to improve performance and accuracy.

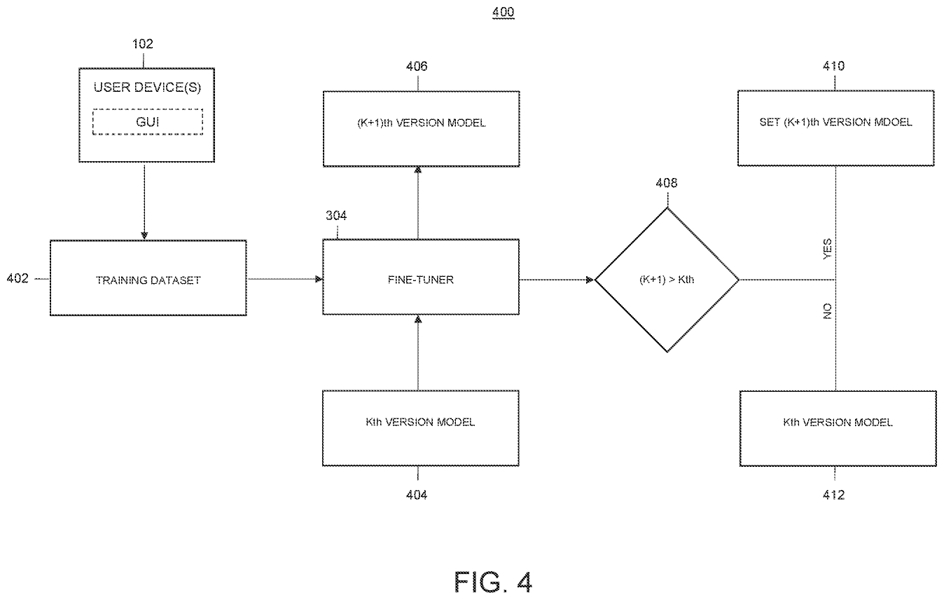

Referencing FIG. 4, a fine tuner workflow 400 is depicted, according to one or more embodiments of the present disclosure. As described as it relates to FIG. 3, each task-specific NLP model avails itself of the knowledge from the language model component 214 and a transfer learning loop framework separate from the other task-specific models. As depicted, the fine-tuner workflow 400 may include user device(s) 102, training dataset 402, and fine-tuner 304. User device(s) 102 may provide training dataset 402 with additional documents (e.g., clinical documents, images, and the like). The fine-tuner may retrain a model (e.g., one or more of the task-specific models: 216, 218, 220, and 222) using the updated training dataset 402. As a result of the fine-tuning procedure, the weights of the original model are updated to account for the characteristics of the updated training dataset 402 and the objects of the model.

For example, the fine-tuner 304 may receive the training dataset 402 that has been updated and update the parameter weights of the Kth version model 404 to create (K+1)th version model 406. If at 408 it is determined that the (K+1)th version model 406 performs better based on the outcome of the evaluation metrics discussed in relation to FIG. 3 than the Kth version model 404, then the (K+1)th version model 406 is set as the model that will be implemented 410. Alternatively, if the (K+1)th version model 406 does not perform better than the Kth version model 404, then the Kth version model will continue to be used 412.

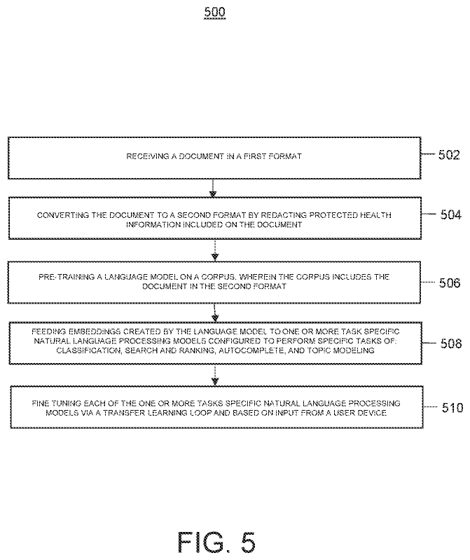

Referencing FIG. 5 a method for training a composite clinical language modeling system 500 is depicted, according to one or more embodiments of the present disclosure. At 502, server system 104 may receive a document in a first format. The document may be a clinical document (e.g., patient health records, patient charts, patient diagnoses, images associated with the patient) that initially includes protected health information. The document may be received over an encrypted network, such as network 108.

At 504, server system 104 may convert the document to a second format by redacting the protected health information included on the document. This may involve implementing one or more computer vision and NLP techniques to identify the protected health information, and remove and/or obfuscate the protected health information. Here, the document may be converted from a first format (e.g., a scanned image, PDF) to machine readable text or image without the protected health information.

At 506, server system 104 may pre-train a language model on a corpus. Server system 104 may pre-train the language model (e.g., the language model implemented by language model component 214) to perform one or more tasks to identify parameters that can be used in one or more downstream tasks. In a non-limiting capacity, the language model implemented by language model component 214 may be pre-trained using one or more of (BERT), (GPT2), and/or (RoBERTA).

At 508, server system 104 may feed the embeddings created by language model component 214 to one or more task-specific NLP models, for example the task-specific NLP models: 216, 218, 220, and 222. Accordingly, each task-specific NLP model can avail itself of the learning and knowledge of the pre-trained language model implemented by language model component 214.

At 510, server system 104 may fine tune each of the one or more task-specific NLP models via a TLL and based on feedback input from user device. Here, each task-specific NLP model may leverage the embeddings created by language model component 214 and fine tune each task-specific NLP model on its unique training dataset. For example, the autocomplete model implemented by autocomplete component 220 may receive word embeddings from language model component 214. The autocomplete may be fine-tuned to with a training dataset comprised of a corpus meant to specifically aid the autocomplete model in improving its performance generate autocomplete suggestions. Notably, similar fine-tuning methods are applied to each task-specific NLP model.

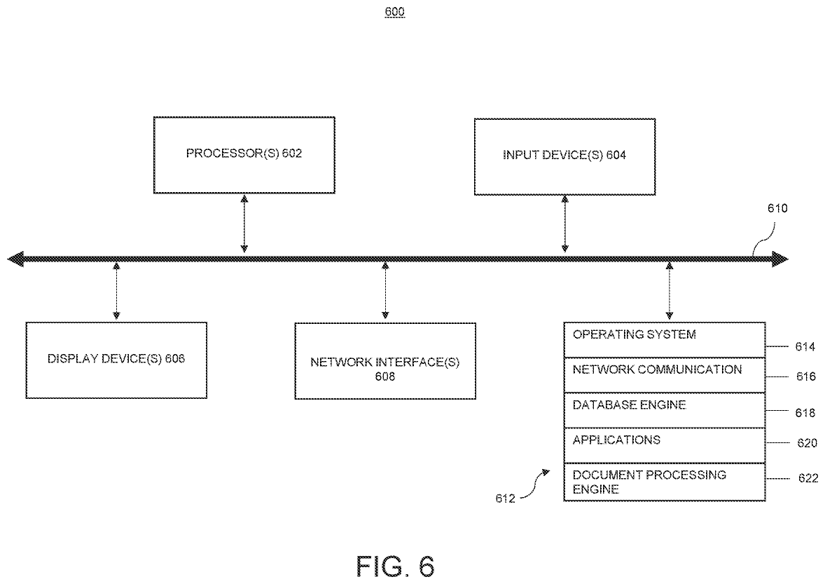

FIG. 6 illustrates a block diagram for a computing device, according to various embodiments of the present disclosure. For example, computing device 600 may function as server system 104. The computing device 600 may be implemented on any electronic device that runs software applications derived from compiled instructions, including without limitation personal computers, servers, smart phones, media players, electronic tablets, game consoles, and email devices. In some implementations, the computing device 600 may include processor(s) 602, input device(s) 604, display device(s) 606, network interfaces 608, and computer-readable medium(s) 612 storing software instructions. Each of these components may be coupled by bus 610, and in some embodiments, these components may be distributed among multiple physical locations and coupled by a network 108.

Display device(s) 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device(s) 604 may be any known input device technology, including but not limited to a keyboard (including a virtual keyboard), mouse, track ball, camera, and touch-sensitive pad or display. Bus 610 may be any known internal or external bus technology, including but not limited to industry standard architecture (ISA), extended industry standard architecture EISA, peripheral component interconnect (PCI), peripheral component interconnect (PCI) Express, universal serial bus (USB), Serial advanced technology attachment (ATA), or FireWire. Computer-readable medium(s) 612 may be any non-transitory medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium(s) 612 may include various instructions for implementing an operating system 614 (e.g., Mac OS®, Windows®, Linux). The operating system may be multi-user, multiprocessing, multitasking, multithreading, real-time, and the like. The operating system may perform basic tasks, including but not limited to: recognizing input from input device(s) 604; sending output to display device(s) 606; keeping track of files and directories on computer-readable medium(s) 612; controlling peripheral devices (e.g., disk drives, printers) which can be controlled directly or through an input/output (I/O) controller; and managing traffic on bus 610. Network communications instructions 616 may establish and maintain network connections (e.g., software for implementing communication protocols, such as TCP/IP, HTTP, Ethernet, telephony).

Database processing engine 618 may include instructions that enable computing device 600 to implement one or more methods as described herein. Application(s) 620 may be an application that uses or implements the processes described herein and/or other processes. The processes may also be implemented in operating system 614. For example, application(s) 620 and/or operating system 614 may execute one or more operations to intelligently process documents (i.e., clinical documents) via one or more natural language processing and/or machine learning algorithms.

Document processing engine 622 may be used in conjunction with one or more methods as described above. Upload documents (e.g., clinical documents) received at computing device 600 may be fed into document processing engine 622 to analyze and classify the documents and provide information and suggestions about the document to a user in real-time.

The described features may be implemented in one or more computer programs that may be executable on a programmable system including at least one programmable processor coupled to receive data and instructions from, and to transmit data and instructions to a data storage system (e.g., database(s) 106), at least one input device, and at least one output device. A computer program is a set of instructions that can be used, directly or indirectly, in a computer to perform a certain activity or bring about a certain result. A computer program may be written in any form of programming language (e.g., Janusgraph, Gremlin, Sandbox, SQL, Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

It is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

What is claimed is:

1. A system comprising:
a server comprising one or more processors; and
a non-transitory memory, in communication with the server, storing instructions that when executed by the one or more processors, cause the one or more processors to implement a method comprising:
receiving a document in a first format;
converting the document to a second format by redacting protected health information included on the document;
pre-training a language model on a corpus, wherein the corpus includes the document in the second format;
feeding embeddings created by the language model to one or more task-specific natural language processing models; and
fine tuning each of the one or more task-specific natural language processing models via a transfer learning loop and based on input from a user device.

2. The system of claim 1, further comprising wherein each of the one or more task-specific natural language processing models each include its own transfer learning loop and training dataset.

3. The system of claim 1, wherein each of the one or more task-specific natural language processing models each are fine-tuned based on its own task-specific training dataset.

4. The system of claim 1, wherein the input from the user device includes feedback; and wherein each of the one or more task-specific natural language processing models are configured to receive feedback from the user device in response to performing its specific natural language processing function.

5. The system of claim 4, wherein the feedback includes data indicative of a confirmation or a correction of an output provided to the user device by the one or more task-specific natural language processing models.

6. The system of claim 1, wherein the language model is trained on a training dataset including medical lexicon, clinical documents, and clinical images.

7. The system of claim 1, wherein the one or more task-specific natural language processing models are configured to perform specific tasks of: classification, search and ranking, autocomplete, and topic modeling.

8. A computer-implemented method comprising:
receiving a document in a first format;
converting the document to a second format by redacting protected health information included on the document;
pre-training a language model on a corpus, wherein the corpus includes the document in the second format;
feeding embeddings created by the language model to one or more task-specific natural language processing models; and
fine tuning each of the one or more task-specific natural language processing models via a transfer learning loop and based on input from a user device.

9. The computer-implemented method of claim 8, further comprising wherein each of the one or more task-specific natural language processing models each include its own transfer learning loop and training dataset.

10. The computer-implemented method of claim 8, wherein each of the one or more task-specific natural language processing models each are fine-tuned based on its own task-specific training dataset.

11. The computer-implemented method of claim 8, wherein the input from the user device includes feedback; and wherein each of the one or more task-specific natural language processing models are configured to receive feedback from the user device in response to performing its specific natural language processing function.

12. The computer-implemented method of claim 11, wherein the feedback includes data indicative of a confirmation or a correction of an output provided to the user device by the one or more task-specific natural language processing models.

13. The computer-implemented method of claim 8, wherein the language model is trained on a training dataset including medical lexicon, clinical documents, and clinical images.

14. The computer-implemented method of claim 8, wherein the one or more task-specific natural language processing models are configured to perform specific tasks of: classification, search and ranking, autocomplete, and topic modeling.

15. A non-transitory computer-readable medium storing instructions, that when executed by one or more processors, cause the one or more processors to implement the instructions for:
receiving a document in a first format;
converting the document to a second format by redacting protected health information included on the document;
pre-training a language model on a corpus, wherein the corpus includes the document in the second format;
feeding embeddings created by the language model to one or more task-specific natural language processing models; and
fine tuning each of the one or more task-specific natural language processing models via a transfer learning loop and based on input from a user device.

16. The non-transitory computer-readable medium of claim 15, further comprising wherein each of the one or more task-specific natural language processing models each include its own transfer learning loop and training dataset.

17. The non-transitory computer-readable medium of claim 15, wherein each of the one or more task-specific natural language processing models each are fine-tuned based on its own task-specific training dataset.

18. The non-transitory computer-readable medium of claim 15, wherein the input from the user device includes feedback; and wherein each of the one or more task-specific natural language processing models are configured to receive feedback from the user device in response to performing its specific natural language processing function.

19. The non-transitory computer-readable medium of claim 18, wherein the feedback includes data indicative of a confirmation or a correction of an output provided to the user device by the one or more task-specific natural language processing models.

20. The non-transitory computer-readable medium of claim 15, wherein the language model is trained on a training dataset including medical lexicon, clinical documents, and clinical images; and
wherein the one or more task-specific natural language processing models are configured to perform specific tasks of: classification, search and ranking, autocomplete, and topic modeling.
